(19) United States
(12) Patent Application Publication
(10) Pub. No.: US 2003/0229535 A1
(43) Pub. Date: Dec. 11, 2003

(54) System that unitarily manages inventory

(76) Inventor: Kazuhiro Tanaka, Tokyo (JP)

Correspondence Address: BURNS, DOANE, SWECKER & MATHIS, L.L.P., P.O. Box 1404, Alexandria, VA, 22313-1404, US

(21) Appl. No.: 10/279,064

(22) Filed: Oct. 24, 2002

(30) Foreign Application Priority Data
Jun. 6, 2002 (JP) 2002-166206

(51) Int. Cl. G06F 17/60

(52) U.S. Cl. 705/10

(57) ABSTRACT

Inventory information and trend information of each product on each section in a distribution system is acquired and unitarily managed. An instruction to increase or decrease number of products to be manufactured is automatically issued to the plant based on the acquired information. For example, if there is a decrease in the number of products in the stock in the retail store, then an instruction is issued to the plant to increase the production.

### BACKGROUND OF THE INVENTION

1) Field of the Invention

The present invention relates to an inventory management system which can automatically order products and automatically adjust the number of products in stock by unitarily grasping the number of products in stock in a product physical distribution from product manufacturing to the end of the physical distribution.

2) Description of the Related Art

Conventionally, the number of products in stock are managed individually by each section in a physical distribution such as the individual buyer (end market), clients (retailer), sales divisions (direct sales shop), and manufacturing plants (plant).

The conventional system will be explained in detail using FIG. 8. Assume that information on respective sections in the physical distribution are such that end market information is A, client information is B, sales division information is C, and plant inventory information is D. Then, a product manufacturing instruction is issued to the plant mainly based on the sales division information C. That is, the end market information A and the client information B do not sufficiently reflect on the product manufacturing in the plant. As a result, the product manufacturing for which the information on the respective sections are integrally taken into consideration cannot be realized.

Precisely, the conventional system has following disadvantages. That is, a) the number of products in stock in the physical distribution unnecessarily increases, b) the operation of the physical distribution is inefficient, c) instruction on manufacturing a product (manufacturing instruction) to the plant is delayed, and c) timely shipment and inventory management cannot be realized.

Thus, in the conventional system, the number of manufactured products cannot be increased or decreased timely and it is not possible to maintain appropriate number of products in stock because of the insufficient inventory management.

### SUMMARY OF THE INVENTION

It is an object of this invention to provide an inventory management system which can unitarily check the number of products in stock in each section of the physical distribution and which enables automation to realize timely plant manufacturing in integral consideration of information on the respective sections.

In the inventory management system according to one aspect of the present invention, an information acquiring unit acquires inventory information and trend information of products on a plurality of sections in a physical distribution system. A managing unit unitarily manages at least one of the end market information, client information, sales division information, and plant inventory information and the trend information in each section in the physical distribution system. The managing unit also decides whether to increase or decrease the production based on the managed information. An instruction issuing unit issues an appropriate manufacturing instruction based on the decision taken by the managing unit. Here, the inventory information including at least end market information, client information, sales division information, and plant inventory information. As a result it becomes possible to unitarily manage the inventory and increase or decrease the production according to needs.

These and other objects, features and advantages of the present invention are specifically set forth in or will become apparent from the following detailed descriptions, of the invention when read in conjunction with the accompanying drawings.

### BRIEF DESCRIPTION OF THE DRAWINGS

FIG. 1 is a block diagram that explains the principle of an inventory management system according to a first embodiment of the present invention,

FIG. 2 is an inventory status diagram which shows one concrete example of the first embodiment,

FIG. 3 is an inventory status diagram which shows another concrete example of the first embodiment,

FIG. 4 is a trend chart of an inventory management system in a second embodiment of the present invention,

FIG. 5 is an inventory status diagram of an inventory management system in a third embodiment of the present invention,

FIG. 6 is an inventory status diagram of an inventory management system in a fourth embodiment of the present invention,

FIG. 7 is a schematic block diagram of the overall inventory management system according to the present invention, and

FIG. 8 is an explanatory view which shows a conventional art.

### DETAILED DESCRIPTIONS

Embodiments of the inventory management system of the present invention will be explained hereinafter in detail with reference to the accompanying drawings.

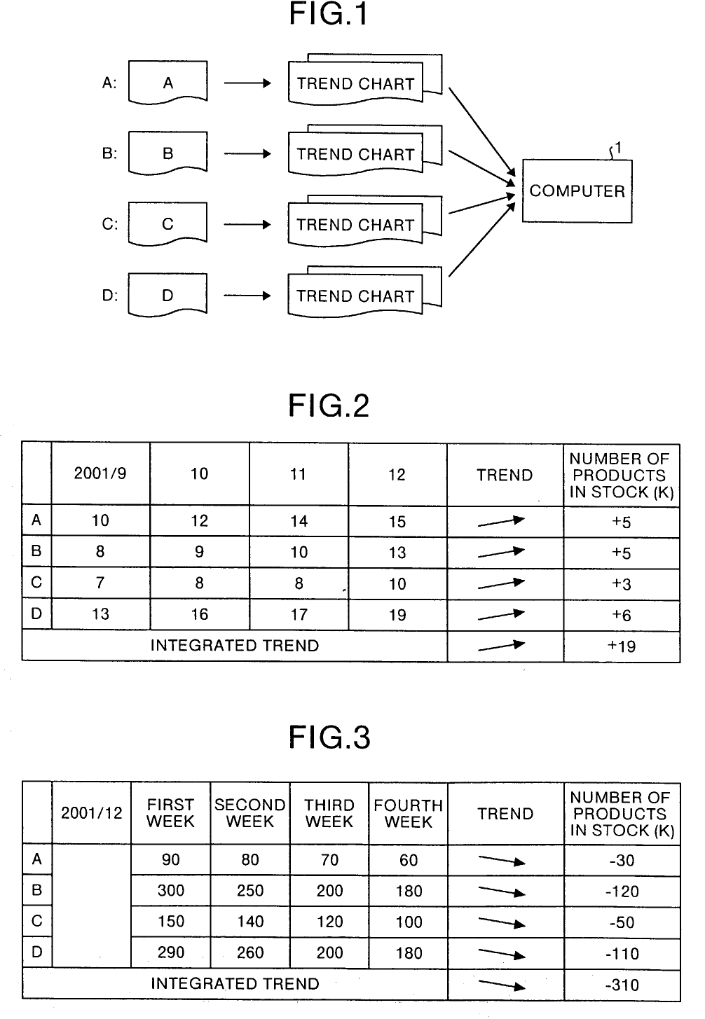

FIG. 1 is a block diagram of an inventory management system according to a first embodiment of the present invention. In FIG. 1, as information on the respective sections of a physical distribution are assumed such that A is end market information, B is client information, C is sales division information and D is plant inventory information. These pieces of information are batch-processed and unitarily managed by a same computer 1. In other words, information (the number of products in stock and a trend thereof, a trend chart) on a computer disposed in each section is output to a host computer 1. In this case, the host computer 1 may exchange information with the respective sections through a server using the network which is established.

The information on the respective sections are present in A: the end market information, B: the client information, C: the sales division information and D: the plant inventory information with respect to the number of products in stock (or, conversely speaking, consumption), and managed according to the time. As a result, a system which can grasp the trends of the respective number of products in stock is established.

FIG. 2 is a shows the concrete statuses of the number of products in stock. In FIG. 2, changes in the number of products in stock from September 2001 (which means September, 2001) to 12 (which means December) and trends thereof are shown for A: the end market information, B: the client information, C: the sales division information and D: the plant inventory information, respectively.

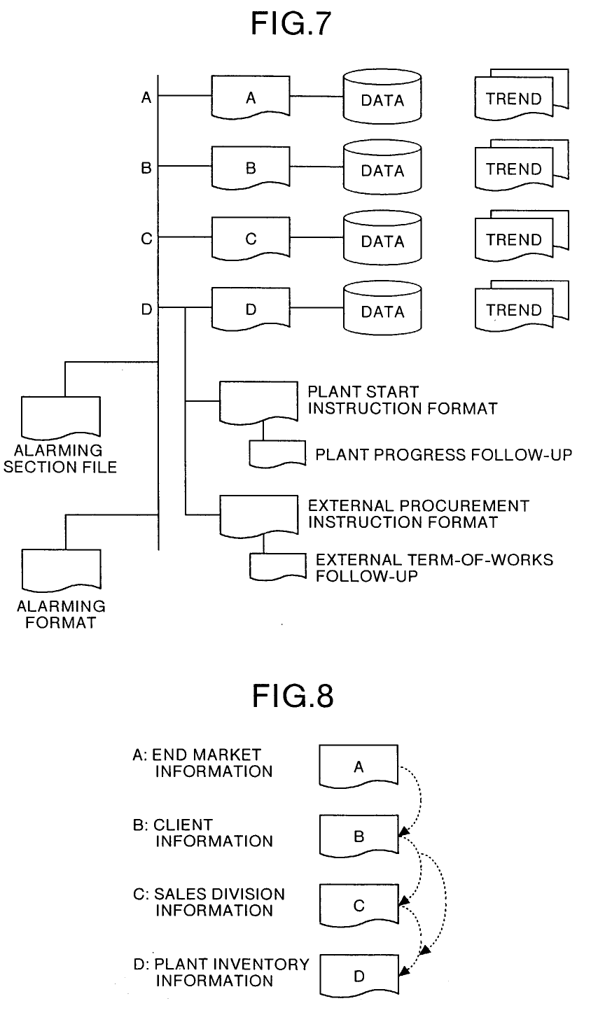

In FIG. 2, K means ×1000. The information on each section is such that the number of products in stock increases in each section as indicated by each trend. As an integrated trend, a manufacturing instruction to decrease in production is automatically issued to the plant of a manufacturer or if the earlier outside procurement of products is made (see FIG. 7), orders are automatically stopped. An automatic program can deal with whether to set an instruction value to instruct the plant to decrease in production at a value which corresponds to +19 as the numerical value of the integrated trend or at a value which corresponds to, for example, half of this value, i.e., +9.5, depending on product attributes or statuses. In this case, even if C: the sales division information is not provided, an instruction to decrease in production is automatically issued to the plant. This is because the number of products in stock in the end section increases. That is, the information on the respective sections is weighted. It is noted that a right upward trend in the inventory status diagram shown in FIG. 2 indicates an increase in the number of products in stock.

FIG. 3 is an inventory status diagram which shows changes in the number of products in stock from the first to fourth weeks of December 2001 and trends in the respective sections. In FIG. 3, as indicated by right downward trends, the number of products in stock decrease in all the sections, contrary to the trends shown in FIG. 1 and an instruction to increase in production is issued automatically, as an integrated trend, to the plant. An automatic program can deal with whether to set an instruction value to instruct the plant to increase in production at a value which corresponds to −310 as the numerical value of the integrated trend or at a value which corresponds to, for example, about two-thirds of this value, i.e., −220, depending on product attributes or statuses. In this case, even if C: the sales division information is not provided, an instruction to increase in production is automatically issued to the plant. This is because the number of products in stock in the end section decreases. The information on the respective sections is weighted, as in the previous case.

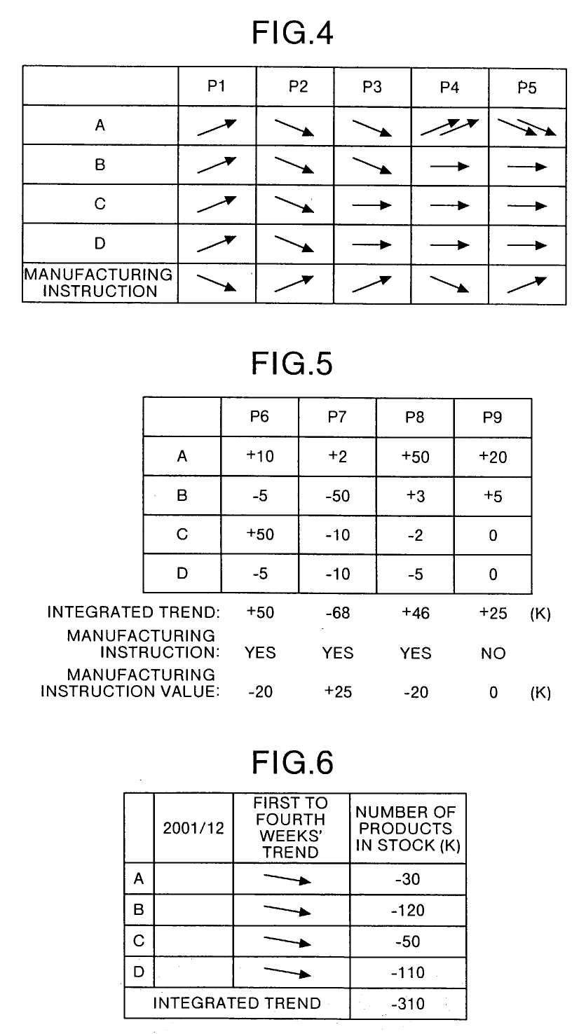

FIG. 4 is a trend chart according to the second embodiment of the present invention. The number of products in stock are quantitatively grasped in predetermined periods (P1 to P5) in the respective sections, the integrated number of products in stock are checked and then batch-processed as trends. Using the trends, a determination, an instruction and a manufacturing instruction value as to whether to increase or decrease the number of products manufactured are set.

In the period P1, there is an increase in the number of products in stock in all the sections and a decrease in the manufacturing instructions. In the period P2, there is an decrease in the number of products in stock in all the sections and also an increase in the manufacturing instructions. In the period P3, there is no increase or decrease in the number of products in stock in the sales division and the plant, a decrease in the number of products in stock in the end market, and an increase in the manufacturing instructions. In the period P4, there is a steep increase in the number of products in stock in the end market, but there is no increase or decrease in the number of products in stock in the other sections, and a decrease in the manufacturing instructions. In the period P5, there is a steep decrease in the number of products in stock in the end market, but there is no increase or decrease in the number of products in stock in the other sections, and an increase in the manufacturing instructions. It is possible to incorporate a software which processes the number of products in stock according to the trends into the system.

FIG. 5 is an inventory status diagram according to the third embodiment of the present invention. Similarly to FIG. 4, the number of products in stock are quantitatively grasped in predetermined periods (P6 to P9) in the respective sections, the integrated number of products in stock are checked and batch-processed. Using the trends, a determination, an instruction and a manufacturing instruction value as to whether to increase or decrease the number of products manufactured are set. In this embodiment, it is determined whether the integrated number of products in stock is +or −. A program for setting a manufacturing instruction value at −20 to decrease in production if the integrated number of products in stock becomes, for example, +30 and for setting a manufacturing instruction value at +25 to increase in production if the integrated value of products in stock becomes, for example, −30, is created. A manufacturing instruction is issued according to this program.

FIG. 6 is an inventory status diagram according to the fourth embodiment of the present invention. FIG. 6 shows a case in which the number of products in stock decrease in the first to fourth weeks of December 2001 in all the sections and it is necessary to increase the number of products manufactured, a case that products cannot be manufactured in the plant within the term of works, and a case that an automatic manufacturing instruction is issued to the outside to procure products. That is, in a program, it is first determined whether or not the integrated number of products in stock of −310, shown in FIG. 6, indicates the term of works in which an order can be placed with the plant for products.

If the products can be manufactured within the term of works, a product manufacturing instruction is issued to the plant of the manufacturer. If not, an automatic manufacturing instruction/procurement is issued/made to the outside so as to enable earlier production (or sometimes in parallel, order with the plant is made). Thereafter, delivery scheduling is checked if outside production is determined, and it is determined whether products can be delivered according to the schedule (as follow-up operation) If there is a probability of a delay in the time of delivery, a predetermined alarm section is provided with an automatic alarm function (e.g., e-mail, FAX or IP telephone) so that an alarm in a predetermined format can be activated to thereby deliver products in time.

If an order is placed with the plant for products and an instruction to manufacture products is issued to the plant based on an increase in production, then the following program may be considered. An order is placed with the plant for product manufacturing, the progress status is checked and it is determined whether it is possible to achieve progress in manufacturing (as follow-up). If trouble occurs and the trouble delays progress in manufacturing, then it is determined whether or not the delay is not shorter than a preset delay. If such a delay occurs, an alarm in a predetermined format is given to a predetermined production section (by E-mail, FAX, IP telephone or the like) to inform the production section of the delay to thereby accelerate progress. After accelerating progress, the time of delivery is checked and it is determined whether products can be delivered within the time of delivery. If there is no way of avoiding a delay in the time of delivery, it is considered to procure products from outside. If it is determined that the product procurement from the outside enables the products to be delivered at earlier time and that the number of products in stock by the procurement is satisfactory, then an order is placed with the outside for products. Even if the procurement from the outside does not enable the products to be delivered in time, an alarm in a predetermined format is activated to contact with a predetermined internal division. By thus establishing the system, it is possible to automatically adjust the number of products in stock, to timely, accurately instruct the number of products manufactured and to thereby ensure smooth operation of the product physical distribution system.

FIG. 7 shows the overall inventory management system according to the present invention. A file which stores A: end market information for the end market, a file which stores B: client information for clients, a file which stores C: sales division information for the sales division and a file which stores D: plant inventory information for inventory of products in the plant are provided. These files include respective trends. In addition, a plant start instruction format and a plant progress follow-up or an external procurement instruction format and an external term-of-works follow-up are incorporated in the plant information. Further, the system includes an alarming section file and an alarming format.

According to one aspect of the present invention, it is possible to unitarily check the number of products in stock in the respective sections of the physical distribution, to appropriately adjust and set the number of products in stock, i.e., to timely increase or decrease the number of products manufactured and to thereby eliminate ill influences of the unnecessary increase of inventory, the inefficient management of the system, a delay in manufacturing instruction and the like.

Moreover, it is possible to timely and objectively determine whether to increase or decrease in production.

Furthermore, it is possible to make an accurate determination in light of product attributes, the statues of the respective sections and manufacturing periods.

Moreover, it is possible to set a reference value to thereby quantitatively grasp the number of products in stock in accordance with the product attributes and the like.

Furthermore, it is possible to surely, flexibly adjust the number of products in stock including an outside procurement instruction.

Moreover, if the progress is greatly deviated from a predetermined set value (progress), an alarm can be automatically activated to thereby increasingly ensure the adjustment of the number of products in stock.

Furthermore, if the progress is deviated from a predetermined set value (term of works), outside procurement can be automatically made to thereby increasingly ensure the adjustment of the number of products in stock.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. An inventory management system comprising:
an information acquiring unit that acquires inventory information and trend information of products on a plurality of sections in a physical distribution system, the inventory information including at least end market information, client information, sales division information, and plant inventory information;
a managing unit that unitarily manages at least one of the end market information, client information, sales division information, and plant inventory information and the trend information in each section in the physical distribution system, and decides whether to increase or decrease the production based on the managed information; and
an instruction issuing unit that issues an appropriate manufacturing instruction based on the decision taken by the managing unit.

2. The inventory management system according to claim 1, wherein
the managing unit automatically decides whether to increase or decrease the production based on a program generated using attribute or status of the product.

3. The inventory management system according to claim 1, further comprising a weight adding unit that adds a preset weight to at least one of the information acquired by the information acquiring unit.

4. The inventory management system according to claim 1, wherein
the managing unit decides whether to increase or decrease the production based on a predetermined manufacturing instruction value which is set according to the inventory information on each section in the physical distribution system.

5. The inventory management system according to claim 1, wherein
the instruction issuing unit issues the manufacturing instruction to a manufacturing plant owned by the manufacturer or to a manufacturing plant owned by a different manufacturer.

6. The inventory management system according to claim 5, wherein the instruction issuing unit issues the manufacturing instruction to the manufacturing plant owned by the manufacturer, the inventory management system further comprising:
an alarm generating unit that acquires information on a deliver time of the products from the manufacturing plant, acquires information on whether the products are being delivered to each section in the physical distribution system as scheduled, and automatically generates an alarm with respect to that section in the physical distribution system to which the delivery of the product is going to delayed.

7. The inventory management system according to claim 5, wherein the instruction issuing unit issues the manufacturing instruction to the manufacturing plant owned by the manufacturer, the inventory management system further comprising:
a deliver time checking unit that acquires information on a deliver time of the products from the manufacturing plant, acquires information on whether the products are being manufactured as scheduled,
wherein the instruction issuing unit issues the manufacturing instruction to the manufacturing plant owned by the different manufacturer when the information acquired by the deliver time checking unit indicates that the manufacturing of the products is going to be delayed.
